(19) United States
(12) Patent Application Publication
(10) Pub. No.: US 2021/0191354 A1
(43) Pub. Date: Jun. 24, 2021

(54) CONFIRMATION METHOD AND SYSTEM FOR TOOL OF MACHINING PROCESS

(71) Applicant: INDUSTRIAL TECHNOLOGY RESEARCH INSTITUTE, HSIN-CHU (TW)

(72) Inventor: CHIH-PING CHENG, Miaoli County (TW)

(21) Appl. No.: 16/903,681

(22) Filed: Jun. 17, 2020

(30) Foreign Application Priority Data
Dec. 24, 2019 (TW) 108147371

(51) Int. Cl. G05B 19/048

(52) U.S. Cl. CPC G05B 19/048; G05B 2219/35398; G05B 2219/35519

(57) ABSTRACT

A confirmation method for a tool of a machining process, applied to detect a health status of a tool changing device, includes following steps: obtaining tool data of a processing equipment from a storage unit of the tool through a first wireless transmission module; interpreting tool data, and converting an interpreting result into a tool assembling status data string; interpreting a tool acquirement corresponding to a process of a processing program, and converting the interpreting result into a process-related tool acquirement data string; and, comparing the tool assembling status data string with the process-related tool acquirement data string, and outputting a program and tool matching data string. In addition, a system for confirming a tool of a machining process is also provided.

### CROSS REFERENCE TO RELATED APPLICATION

This application claims the benefits of Taiwan application Serial No. 108147371, filed Dec. 24, 2019, the disclosures of which are incorporated by references herein in its entirety.

### TECHNICAL FIELD

The present disclosure relates in general to machining technology, and especially to a method and a system for verifying a tool applied to a machining process while a machine tool undergoes a processing program and also for determining a health status of a tool-changing device.

### BACKGROUND

While a CNC (Computer Numerical Control) processing equipment is used for performing a machining process, after a tool is mounted onto the processing equipment, and a CNC controller is applied to read a corresponding processing program (including tool moving paths and machining loads); the tool would follow the processing program to perform material removal from a workpiece. Typically, an entire machining process of the processing program is consisted of different sub-processes paired with different tools. For example, while in performing an external contour turning, the process requires a processing program having at least an OD (Outer Diameter) turning tool and a sub-program for contour machining. For another example, while in machining an external pocket, the process requires another processing program having at least an endmill tool- and a sub-program for machining the external pocket. For one more example, while in drilling a hole, the process requires a processing program having at least a drilling tool and a sub-program for hole drilling.

Generally speaking, in facing a machining task for a complicated pattern, a commercial CAD/CAM software package would be applied to perform editing of a feasible processing program. After the editing of the processing program is complete, the software can generate a machining process sheet containing various machining paths, associated tool types, specifications and mounting direction on the processing equipment. The required tools are then mounted manually to the processing equipment according to the is machining process sheet. Then, the processing program is performed to complete the scheduled machining a workpiece on the processing equipment. However, the aforesaid manual tool-mounting procedure may involves some uncertainties related to human errors, such as using a wrong tool type or specification, mounting the tool with a wrong tool number, a wrong tool direction (by having mill-turn machine tools as an example, in mounting a tool onto a rotary turret, a specific direction for mounting the tool would be elucidated in the machining process sheet such as an axial mounting or a radial mounting), or a wrong direction of the cutting edge. Any of these mistakes would lead to mis-matching between the tool and the processing program during the real machining period, from which the machined workpieces would be scrapped or less qualified, or severely from which a cutting hit at the machining equipment to cause a safety problem might be inevitable.

Further, during a machining process of the CNC machine, since too many sub-processes are involved, thus a tool-changing device shall be applied to perform in-process changes of tools. However, as long as the tool-changing device on the CNC machine is aged or failed, negative effects upon the machining process and the machining precision can be foreseen.

Accordingly, an improved confirmation method and system for tools of a machining process that can correctly verify the instant tool and determine the health status of the tool-changing device prior to perform the processing program is definitely urgent to the skill in the art.

### SUMMARY

In one embodiment of this disclosure, a method for confirming a tool of a machining process is applied to an electronic device. The electronic device, having a processing program storage device, is connected with a processing equipment furnished with tools and a first wireless transmission module. Each of the tools mounted on the processing equipment at respective positions having individual tool numbers is furnished at least with a built-in second wireless transmission module, an inertial sensor, a storage unit and a processing unit. The electronic device performs the steps of:

applying the first wireless transmission module to acquire data in the storage unit of each of the tools on the processing equipment;

analyzing the data acquired from the storage unit to obtain an analyzing result, and transforming the analyzing result into a corresponding tool assembling-status data string, wherein the analyzing result includes one of the tool numbers, a tool type, a tool specification and a tool assembly direction;

acquiring a processing program from the processing program storage device, analyzing a tool acquirement corresponding to each of processes in the processing program, and transforming the tool acquirement into a corresponding process-related tool acquirement data string, wherein the tool acquirement includes a required tool number, a required tool type, a required tool specification and a required tool assembly direction; and

comparing the tool assembling-status data string with the process-related tool acquirement data string, and calculating a difference between the tool assembling-status data string and the process-related tool acquirement data string to form a program and tool matching data string as an output.

In another embodiment of this disclosure, a system for confirming a tool of a machining process includes:

a tool confirmation program storage device, used for containing a tool data-analyzing module, a process-related tool acquirement-analyzing module and a process-related tool confirmation module; and

a processor, coupled with the tool confirmation program storage device, used for performing at least one of the tool data-analyzing module, the process-related tool acquirement-analyzing module and the process-related tool confirmation module;

wherein the processor performs the tool data-analyzing module to apply a wireless transmission module to acquire and analyze data inside a storage unit of a tool mounted on the processing equipment at a position having an individual tool number to obtain an analyzing result, and the analyzing result is then transformed into a tool assembling-status data string; wherein the processor performs the process-related tool acquirement-analyzing module to acquire and analyze a tool acquirement respective to a process of a processing problem from a processing program storage device of an electronic device to obtain a tool acquirement information, and the tool acquirement information is transformed into a process-related tool acquirement data string; and, wherein the processor performs the process-related tool confirmation module to compare the tool assembling-status data string with the process-related tool acquirement data string and further to calculate a difference between the tool assembling-status data string and the process-related tool acquirement data string to obtain a matching result, and the matching result is outputted as a program and tool matching data string.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic block view of an embodiment of the system for confirming a tool of a machining process in accordance with this disclosure;

FIG. 2 is an application of the embodiment of the system in FIG. 1, applied to mill-turn machine tools;

FIG. 3 shows schematically tool assembling-status data strings in accordance with this disclosure;

FIG. 4A shows process program codes of the processing program in accordance with this disclosure;

FIG. 4B shows process-related tool acquirement data strings analyzed from the process program codes of FIG. 4A;

FIG. 5A shows process-related tool acquirement data strings in accordance with this disclosure;

FIG. 5B shows the tool assembling-status data string corresponding to FIG. 5A;

FIG. 5C shows the program and tool matching data strings in the circumstance that data strings of FIG. 5A and FIG. 5B are matched with each other;

FIG. 6A shows another process-related tool acquirement data strings in accordance with this disclosure;

FIG. 6B shows the tool assembling-status data string corresponding to FIG. 6A; and

FIG. 6C shows the program and tool matching data strings in the circumstance that data strings of FIG. 6A and FIG. 6B are mis-matched with each other.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

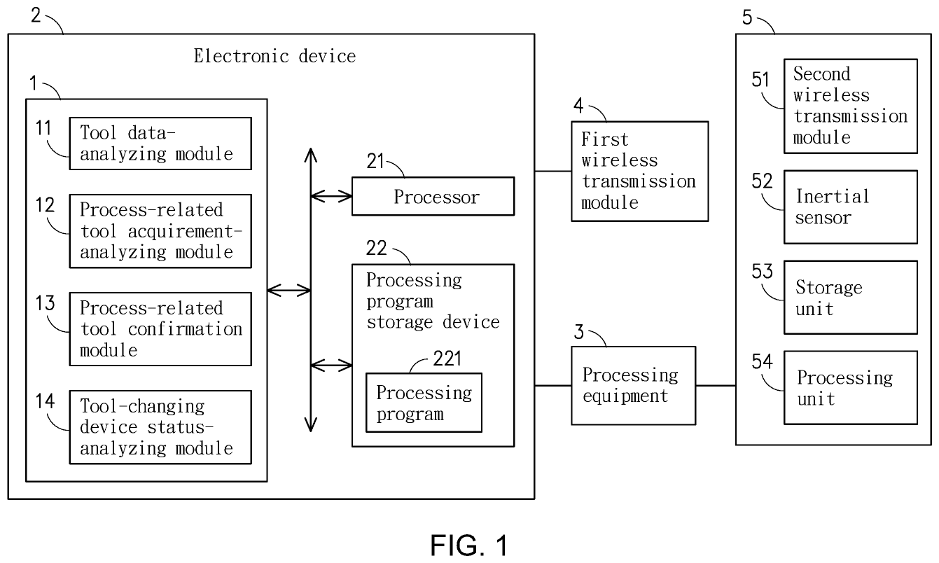

Referring to the embodiment shown in FIG. 1, a system for confirming a tool of a machining process provided by this disclosure, including a tool confirmation program storage device 1, can be applied to an electronic device. In this disclosure, the electronic device 2 can be a server, a mainframe or the like device. In particular, the electronic device 2 can be a controller for mill-turn machine tools.

The tool confirmation program storage device 1 includes a tool data-analyzing module 11, a process-related tool acquirement-analyzing module 12, a process-related tool confirmation module 13 and a tool-changing device status-analyzing module 14.

The electronic device 2 has a processor 21 and a processing program storage device 22. The processor 21 is used for performing the processing program 221 and modules in the tool confirmation program storage device 1, and for installing relevant software (such as an operation system) into the electronic device 2. The processing program storage device 22 or the tool confirmation program storage device 1 can be a hard disc or any other type of storage card or device for storing versatile data such as videos, audios, pictures and data strings.

The electronic device 2 is connected with both the processing equipment 3 and the first wireless transmission module 4. The processing equipment 3 is any apparatus furnished with at least one tool 5, such as a milling machine or a mill-turn machine tool. The first wireless transmission module 4 can be an isolated device connected with the electronic device 2, or a built-in wireless transmission module inside the electronic device 2.

The tool 5, mounted to a position having an individual tool number at the processing equipment 3, includes at least a built-in second wireless transmission module 51, an inertial sensor 52, a storage unit 53 and a processing unit 54. The second wireless transmission module 51 can transmit data stored in the storage unit 53 to the electronic device 2.

The inertial sensor 52 can be one of a gyroscope and an accelerator for detecting dynamic variations of the tool 5; for example, vibrations or variations in acceleration. The storage unit 53 can be a hard disc or any other type of storage card or device for storing versatile data such as videos, audios, pictures and data strings. In this embodiment, the data stored in the storage unit 53 include tool data and inertial sensor data calculated by the processing unit 54. The tool data include a tool number, a tool type, a tool specification. The inertial sensor data calculated by the processing unit 54 can be the tool assembly direction of the tool 5. The processing unit 54 can be a microchip processing module for performing numerical calculation and logical processing.

Referring to FIG. 1, the electronic device 2 acquires the data stored inside the storage unit 53 of the tool 5 with a specific tool number of the processing equipment 3 through the first wireless transmission module 4. The system for confirming a tool of a machining process applies the processor 21 to have the tool data-analyzing module 11 to analyze the data acquired from the storage unit 53 of the tool 5 by the electronic device 2 so as to generate an analyzing result. The analyzing result includes a tool number, a tool type, a tool specification and a tool assembly direction. The analyzing result is then transformed into a data string, called as a tool assembling-status data string.

The system for confirming a tool of a machining process utilizes the processor 21 to have the process-related tool acquirement-analyzing module 12 to obtain the processing program 221 stored in the processing program storage device 22 of the electronic device 2, and further to analyze a tool acquirement respective to a process in the processing program 221. The tool acquirement includes a required tool number, a required tool type, a required tool specification and a required tool assembly direction. The tool acquirement is transformed into a data string, called as a process-related tool acquirement data string.

Thereafter, the system for confirming a tool of a machining process applies the processor 21 to have the process-related tool confirmation module 13 to read the aforesaid tool assembling-status data string and process-related tool acquirement data string, and apply a mathematical method to compare the tool assembling-status data string with the process-related tool acquirement data string, and to calculate a difference of the two data strings. The comparison or matching result can be outputted in a form of data string, called as a program and tool matching data string. The program and tool matching data string can be displayed on a display screen (not shown in the figure) of the electronic device 2.

Regarding the tool data and the inertial sensor data obtained by the electronic device 2, the system for confirming a tool of a machining process utilizes the processor 21 to have the tool data-analyzing module 11 to perform analyzing, and an analyzing result is transformed into a value, called as a tool-changing device health data to be stored in the tool confirmation program storage device 1 as a flag for judging whether or not the health status of the tool changing device is all right. The tool-changing device status-analyzing module 14 obtains the tool-changing device health data from the tool confirmation program storage device 1 of the electronic device 2. The tool-changing device health data is judged by a threshold value, and the result is then outputted as a health status of tool changing device. Similarly, the health status of tool changing device can be displayed on a screen of the electronic device 2.

The type of the first wireless transmission module 4 or the second wireless transmission module 51 is not specifically defined, but can be one of a blue tooth, a Zigbee, an NFC and a WIFI.

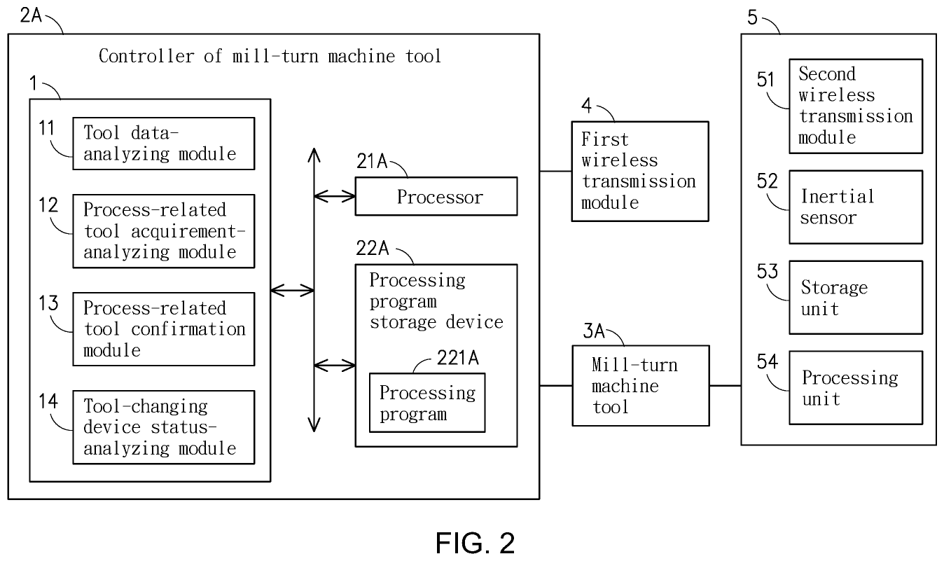

Referring to FIG. 2, a mill-turn machine tool is applied to perform thereon the system and method for confirming a tool of a machining process. The controller 2A of the mill-turn machine tool is connected with the mill-turn machine tool 3A and the first wireless transmission module 4. In this embodiment, the mill-turn machine tool 3A is a processing equipment furnished with a rotary turret able to load 12 tools. Namely, 12 tools can be loaded at the rotary turret of the mill-turn machine tool 3A, and thus the mill-turn machine tool 3A can have 12 tool numbers for different machining processes.

In this embodiment, the tool 5 has at least a built-in second wireless transmission module 51, an inertial sensor 52, a storage unit 53 and a processing unit 54. According to different machining requirements, the tool 5 can be loaded to a specific tool number at the rotary turret of the processing equipment. In this embodiment, the inertial sensor 52 can be an accelerator having a detection direction parallel to an axial direction of the tool.

The data stored in the storage unit 53 of the tool 5 includes the tool information and the inertial sensor data calculated by the processing unit 54. The tool information includes a stored tool number, a stored tool type and a stored tool specification. The inertial sensor data calculated by the processing unit 54 is respective to the tool assembly direction of the tool 5, or can be the locating vibration data of the tool-changing device.

The tool 5, loaded at the rotary turret of the mill-turn machine tool 3A, is changed through a rotation of the rotary turret. During the rotation of the turret, the inertial sensor 52 embedded in the tool 5 would generate different voltage signals according to the tool assembly-direction of the tool 5. The tool assembly-direction is directed to a radial mounting or an axial mounting of the tool 5 with respect to the workpiece. In this embodiment, the inertial sensor 52 is an accelerator able to generate a voltage signal ranging within +2V˜−2V, and is mounted onto the rotary turret via the tool 5 at different direction radially or axially. The tool 5 is changed through rotating the rotary turret.

While in changing the tool 5 through rotating the turret, the voltage signal would be +1.1V if the tool 5 is radially mounted, and +0.3V if the tool 5 is axially mounted. The voltage signal is further processed by the processing unit 54 embedded at the tool 5 to form an inertial sensor data with respect to the tool assembly direction of the tool 5.

To different mounting directions of the tool 5 (axially or radially), the corresponding voltage signals from the inertial sensor 52 during the rotation of the turret would demonstrate a significant difference. Thus, in one embodiment for signal processing, a 0.8V threshold value can be used for classifying the voltage signals.

Thus, while the tool data-analyzing module 11 analyzes the inertial sensor data with respect to the tool assembly direction of the tool 5, the tool assembly posture can be deemed as a radial mounting with a zero inertial sensor data if the voltage signal is greater than 0.8V, and the tool assembly direction can be deemed as an axial mounting with a 1 inertial sensor data if the voltage signal is smaller than 0.8V

Further, in rotating the rotary turret to change the tool directly into position, if the inertial sensor 52 determines a radial mounting at the tool 5 in one embodiment, then the voltage signal generated by the inertial sensor 52 and induced by positioning shakes can be 1.4V for the locating vibration data of the tool-changing device; and, on the other hand, if the inertial sensor 52 determines an axial mounting at the tool 5 in one embodiment, then the voltage signal generated by the inertial sensor 52 and induced by positioning shakes can be 0.6V for the locating vibration data of the tool-changing device.

As long as the rotary turret becomes aged, when the tool 5 is rotated directly into position, since the positioning shakes would instabilize the voltage signal generated by the inertial sensor 52, then remarkable fluctuation at the voltage signal can be expected. For example, in a radial-mounted tool, as long as the rotary turret is aged or failed, the positioning shake would go big and unstable, and thereby the voltage value will not be the original 1.4V, but fluctuates between 1.2˜1.6V. For example, two consecutive tool changes may induce different voltage signals at the inertial sensor 52 from 1.33V to 1.55V.

The first wireless transmission module 4, as an isolated device connected with the controller 2A of the mill-turn machine tool can cooperate with the second wireless transmission module 51 of the tool 5 to perform dual-end signal transmission for obtaining the data in the storage unit 53 of the tool 5, and further for storing the data into the processing program storage device 22A of the controller 2A of the mill-turn machine tool.

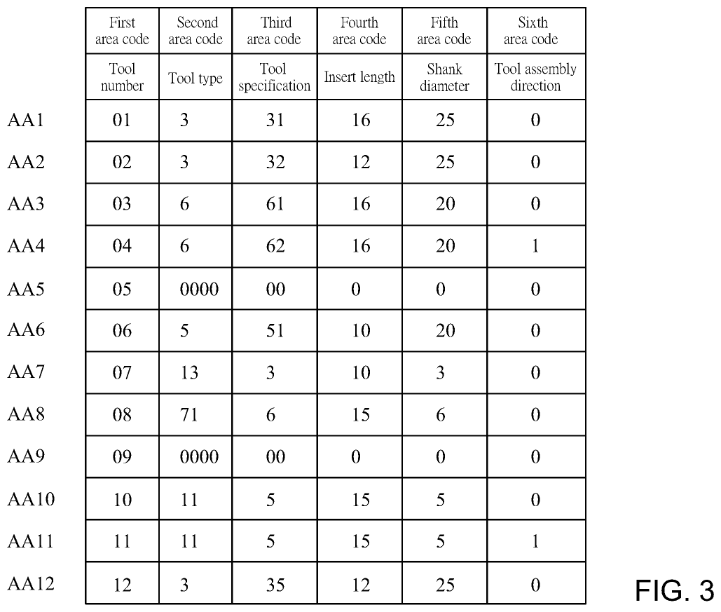

Referring now to FIG. 2 and FIG. 3, 12 tool numbers on the mill-turn machine tool 3A are individually furnished with respective tools 5, and the dual-end signal transmission established by the first wireless transmission module 4 and the second wireless transmission module 51 can be applied to transmit the data stored in the storage unit 53 of the corresponding tool 5. Thereupon, data AA1-AA12 can be transmitted into the processing program storage device 22A of the controller 2A for undergoing a following process.

The system for confirming a tool of a machining process applies the processor 21A to have the tool data-analyzing module 11 to read the 12 data AA1-AA12 already stored in the processing program storage device 22A. Based on these 12 data for analysis, an analyzing result would include a tool number, a tool type, a tool specification, a tool edge length, a shank width and a tool assembly direction. The analyzing result covering these 12 data is then transformed into 12 data strings, i.e., the tool assembling-status data strings AA1-AA12, as shown in FIG. 3. These tool assembling-status data strings would be then transmitted to the controller 2A for further processing.

By having the data AA1 as an example, this data includes tool information (including a tool number, a tool type, and a tool specification) and inertial sensor data calculated by the embedded processing unit 54 (with respect to the tool assembly direction and the locating vibration data of the tool-changing device). The tool data-analyzing module analyzes data AA1 as follows. The tool number 01 in the AA1 data is encoded into 01 by the tool data-analyzing module. The tool type in the AA1 data is an OD turning tool, and would be encoded into 3 by the tool data-analyzing module. In the AA1 data, the tool specification is SVJBR2525M-16. According to ISO standards, this tool is a screw fastened OD turning tool having a V-shape 35° insert, an insert edge length of 16 mm and a shrank diameter of 25 mm, which are encoded into 31, 16, 25, respectively, by the tool data-analyzing module. In the AA1 data, the voltage signal for the radial-mounting direction of the tool in the inertial sensor data is +1.1V, which will be encoded into 0 by the tool data-analyzing module.

The system would integrate the foregoing codes into a tool assembling-status data string AA1. In the tool assembling-status data string AA1, the first area code 01 implies the tool number 01, the second area code 3 implies the tool type of OD turning tool, the third area code 31 implies the tool specification of a 35° V-shape OD turning tool, the fourth area code 16 implies the insert edge length of 16 mm, the fifth area code 25 implies the shank width of 25 mm, and the sixth area code 0 implies that the tool assembly direction is radial with respect to the workpiece at the mill-turn machine tool.

By having the data AA10 as another example, the tool data-analyzing module analyzes data AA10 as follows. The tool number 10 in the AA10 data is encoded into 10 by the tool data-analyzing module. The tool type in the AA10 data is a 5 mm driller having an insert edge length of 15 mm and radially mounted, and thus would be encoded into 11, 5, 15, 5, 0, respectively, by the tool data-analyzing module. The system would integrate the foregoing codes into a tool assembling-status data string AA10. In the tool assembling-status data string AA10, the first area code 10 implies the tool number 10, the second area code 11 implies a driller, the third area code 5 implies a 5 mm OD, the fourth area code 15 implies the insert edge length of 15 mm, the fifth area code 5 implies the shank width of 5 mm, and the sixth area code 0 implies that the tool assembly direction is radial with respect to the workpiece at the mill-turn machine tool.

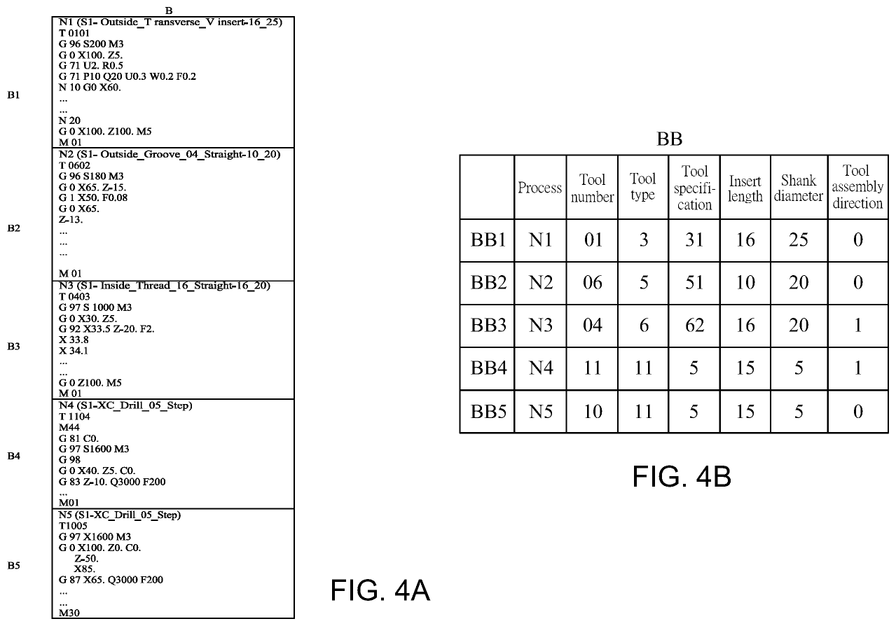

In this embodiment, the system for confirming a tool of a machining process applies the processor 21A to have the process-related tool acquirement-analyzing module 12 of the tool confirmation program storage device 1 to read the processing program 221A in the processing program storage device 22A through internal data transmission of the controller 2A, and further to analyze the tool acquirement with respect to specific process in the processing program 221A. The tool acquirement includes a required tool number, a required tool type, a required tool specification and a required tool assembly direction. The tool acquirement is further transformed into a data string, called as a process-related tool acquirement data string BB (as shown in FIG. 4B).

Refer now to FIG. 4A and FIG. 4B. According to this disclosure, the process-related tool acquirement data string BB with respect to each process of the processing program B (equivalent to the processing program 221A of FIG. 2) can be obtained by reading the processing program B, then analyzing annotation and tool code in each process, and finally performing transformation to form the process-related tool acquirement data string BB.

In FIG. 4A, the processing program B is a program coding having 5 processes with individual annotations. For example, the annotation for the first process B1 is S1-Outside_Transverse_V insert-16_25.

In the annotation of the first process B1, S1-Outside implies that the machining is a contour turning on an XY plane of the first spindle of a lathe, and thus the respective tool type should be an OD turning tool. Transverse in the annotation of the first process B1 implies that the machining is a pattern lathing, and thus the respective machining tool should be posed at a radial-mounting direction. V insert in the annotation of the first process B1 implies that a machining tool with a V-shape insert is adopted, and thus the respective tool specification should be the turning tool with a V-shape insert. 16 in the annotation of the first process B1 implies that the insert edge length is 16 mm, and thus the respective machining tool should be an OD turning tool with a 16-mm length in insert edge. 25 in the annotation of the first process B1 implies that the shank width is 25 mm, and thus the respective machining tool should have a 25 mm shank width. In analyzing the machining tool, the tool code is T0101, implying that the tool at tool number 01 is applied to perform machining according to #1 tool compensation. In analyzing the process number, the process number is N1, implying that this process is the first process.

Then, all the aforesaid analyzing upon the first process B1 is transformed into a corresponding first process-related tool acquirement data string BB1. In the first process-related tool acquirement data string BB1, the first area code is N1, implying this instant process is the first process; the second area code is 01, implying the tool at tool number 01 is applied in this process; and, the third area code is 3, implying the tool type of this process is an OD turning tool.

Further, in the first process-related tool acquirement data string BB1, the fourth area code is 31, implying the tool specification of this process is a turning tool with a V-shape insert; the fifth area code is 16, implying the tool of this process is a turning tool having an insert of 16 mm long; the sixth area code is 25, implying that the tool of this process has a shank width of 25 mm; and, the seventh area code is 0, implying that the tool in this process is radially mounted.

For another example, the annotation for the third process B3 is S1-Inside_Thread_Straight-16_20.

In the annotation of the third process B3, S1-Intside implies that the machining is an inner contour turning on an XY plane of the first spindle of a lathe, and thus the respective tool should have an axial-mounting direction. Thread in the annotation of the third process B3 implies that the machining is a cyclic inner-thread machining, and thus the respective tool type should be an inner threading tool. Straight in the annotation of the third process B3 implies that a machining tool with a 60° tooth-shape insert is adopted, and thus the respective tool specification should be the inner threading tool with a 60° tooth-shape insert. 16 in the annotation of the third process B3 implies that the insert edge length is 16 mm, and thus the respective machining tool should be an inner threading tool with a 16-mm length insert. 20 in the annotation of the third process B3 implies that the shank width is 20 mm, and thus the respective machining tool should have a 20 mm shank diameter. In analyzing the machining tool, the tool code is T0403, implying that the tool at tool number 04 is applied to perform machining according to #3 tool compensation. In analyzing the process number, the process number is N3, implying that this process is the third process.

Then, all the aforesaid analyzing upon the third process B3 is transformed into a corresponding third process-related tool acquirement data string BB3. In the third process-related tool acquirement data string BB3, the first area code is N3, implying this instant process is the third process; the second area code is 04, implying the tool at tool number 04 is applied in this process; and, the third area code is 6, implying the tool type of this process is a threading tool; the fourth area code is 62, implying the tool specification of this process is an inner threading tool with a 60° tooth-shape insert; the fifth area code is 16, implying the tool of this process is an inner threading tool having an insert edge of 16 mm long; the sixth area code is 20, implying that the tool of this process has a shank diameter of 20 mm; and, the seventh area code is 1, implying that the tool in this process is axially mounted.

According to the aforesaid analyzing procedures by the process-related tool acquirement-analyzing module 12, all five processes B1-B5 of the processing program B can be orderly analyzed, and these five process-related tool acquirement data strings BB1-BB5 corresponding to the five processes B1-B5 are then transmitted to the controller for further processing.

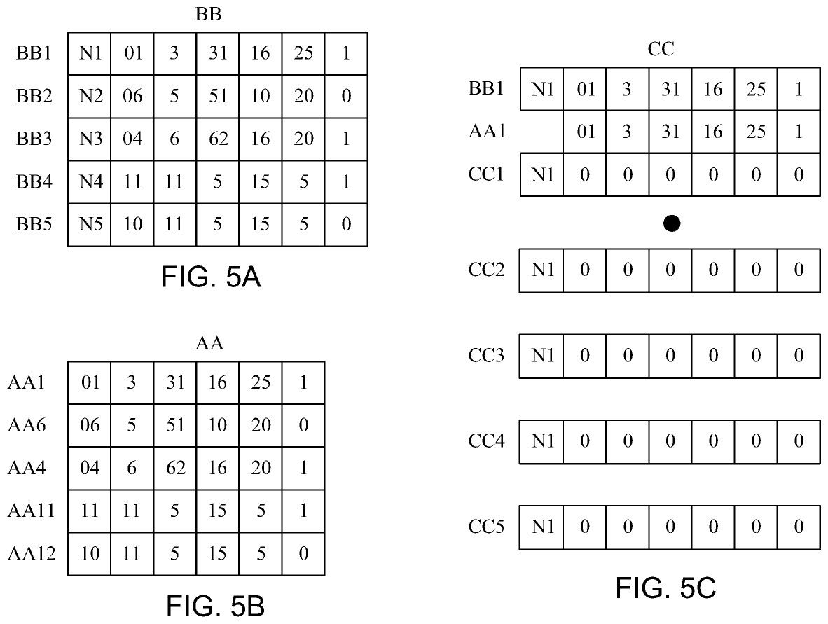

Refer to FIG. 5A through FIG. 5C. A method for generating the program and tool matching data string CC includes the following steps. Firstly, the first process-related tool acquirement data string BB1 is read. Then, according to the second area code 01 (tool number) of the first process-related tool acquirement data string, a corresponding search upon the tool number for all the tool assembling-status data strings AA1-AA12, and a match is located if the first area codes (tool number) of the data strings are the same.

In this embodiment, the match is found at the tool assembling-status data string AA1 (according to the first tool number), and then the first process-related tool acquirement data string BB1 and the matched tool assembling-status data string AA1 are processed by a mathematical method to calculate differences among equivalent segments of the two data strings. The calculation results would be included in a program and tool matching data string CC1 to be displayed on the controller 2A of the mill-turn machine tool.

Similar to the aforesaid matching process, all the processed within the processing program AA would be processed. If all of the program and tool matching data strings CC1-CC5 are 0, it implies that the processing program AA and the respective machining tools on the processing equipment are completely matched, such that safety machining can be expected. On the other hand, if any of the calculated differences are not 0, then it implies that the processing program AA can not be performed safely.

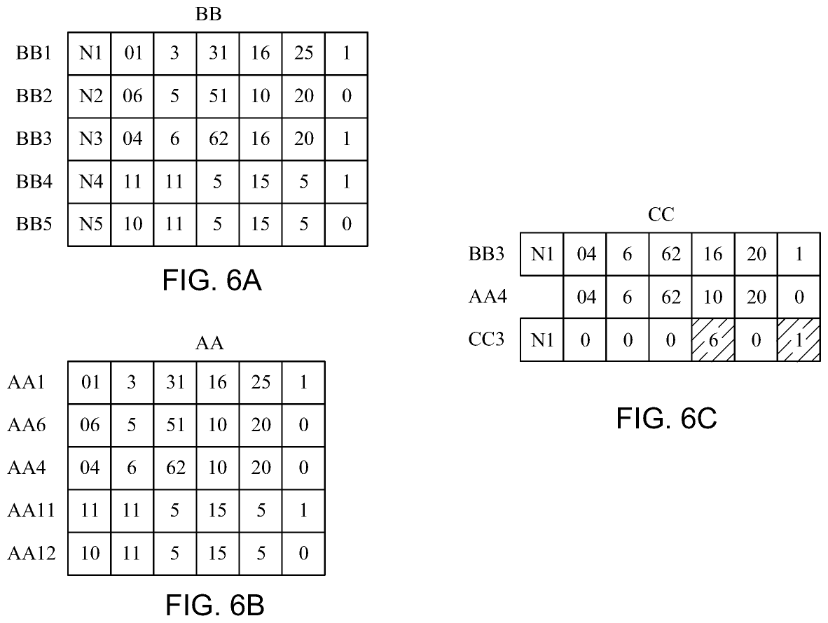

Refer now to FIG. 6A through FIG. 6C. For example, after a matching calculation, it is found that the program and tool matching data string CC3 for the third process A3 of the processing program AA is not 0, it implies that the tool mounted on the mill-turn machine tool for performing the third process A3 of the processing program AA can't meet all the requirements upon the instant process (in tool specification and tool assembly direction), and thus the corresponding machining is not safe.

By having the controller 2A to determine a health status of the rotary-turret tool-changing device, the system for confirming a tool of a machining process applies internal data transmission of the controller 2A to acquire a plurality of recent locating vibration data of the tool-changing device (for example, the last 200), and then mathematical statistics is applied thereupon to perform kurtosis calculation.

In statistics, kurtosis stands for the peak pattern of a real-number random variance distribution. The larger the kurtosis is, the smaller the variance of the collected data would be. The equation thereto is listed as follows:

$$K = \frac{\sum {( {x}_{i} - \overline{x} )}^{4}}{{ns}^{4}} - 4$$

in which s is the standard deviation, n is the number of samples, and x is the variable (voltage in this embodiment).

Generally speaking, when the tool-changing device is healthy, the rotary turret can be rotated directly into position for tool change. While in positioning, the voltage signal generated at the inertial sensor 52 caused by positioning shakes would be stable with smooth fluctuations. In this embodiment, when the tool 5 is radially mounted, as the tool-changing device is applied to change the tool, the detected voltage signal would be around 1.4V with slight fluctuations. As long as the tool-changing device is aged or failed, the tool change by the tool-changing device would induce much severe fluctuations upon the detected voltage signals, for example, ranging from 1.2V to 1.6V, with a +/−0.2 deviation range around 1.4V.

As long as the rotary turret becomes aging, when the tool 5 is rotated directly into position for changing tool, the voltage signals generated by the inertial sensor 52 caused by the positioning shakes would become unstable, and a significant deviation around the original signal value would be produced. By having the radial-mounted tool as an example, as long as the rotary turret becomes aging and less reliable, the positioning of the tool would become unstable, and the corresponding voltage values would be fluctuated between 1.2V and 1.6V, but not usually hit the 1.4V. For example, the voltage signals for two consecutive tool changes may be 1.33V and 1.55V.

For example, to a specific tool, the last 200 locating vibration data of the tool-changing device are collected to be processed statistically by the kurtosis calculation. If the tool-changing device is healthy, the detected voltage values for changing the tool into position would be stable with only slight fluctuations, and thus the calculated kurtosis is above the mesokurtosis (i.e., kurtosis >0). As long as the tool-changing device is aged or failed, the detected voltage values for changing the tool into position would be unstable with significant fluctuations, and thus the calculated kurtosis is below the mesokurtosis (i.e., kurtosis <0).

By applying the tool-changing device status-analyzing module 14 in the controller 2A to acquire the last 200 locating vibration data of the tool-changing device at changing tool into position, the kurtosis is calculated and used for judging the health status of the tool changing device, and the result can be displayed on the controller 2A of the mill-turn machine tool.

Referring to FIG. 1, according to the system for confirming a tool of a machining process provided by this disclosure, a corresponding method for confirming a tool of a machining process can be applied to the electronic device 2. The electronic device 2 has a processing program storage device 22, and the electronic device 2 is connected with the processing equipment 3 having the tool 5 and the first wireless transmission module 4. The tool 5 on the processing equipment 3 at a position having an individual tool number is furnished at least with a built-in second wireless transmission module 51, an inertial sensor 52, a storage unit 53 and a processing unit 54. The method applies the electronic device 2 to perform the steps of:

(a) applying the first wireless transmission module 4 to acquire data in the storage unit 53 of each of the tools 5 on the processing equipment 3;

(b) analyzing the data acquired from the storage unit 53 to obtain an analyzing result, and transforming the analyzing result into a corresponding tool assembling-status data string, wherein the analyzing result includes a tool number, a tool type, a tool specification and a tool assembly direction;

(c) acquiring a processing program 221 from the processing program storage device 22, analyzing a tool acquirement corresponding to each of processes in the processing program 221, and transforming the tool acquirement into a corresponding process-related tool acquirement data string, wherein the tool acquirement includes a required tool number, a required tool type, a required tool specification and a required tool assembly direction; and

(d) comparing the tool assembling-status data string with the process-related tool acquirement data string, and calculating a difference between the tool assembling-status data string and the process-related tool acquirement data string to form a program and tool matching data string as an output.

In summary, in the method and system for confirming a tool of a machining process provided by this disclosure, prior to a machining process, the tool defined by the processing program can be correctly mounted to the processing equipment, and a verification system and method can be automatically performed to verify whether matching in between is fulfilled. The method and system for confirming a tool of a machining process can avoid human errors and uncertainties, such that the machining process can be performed accurately. Thereupon, quality and safety machining can be achieved. In addition, the system of this disclosure can also judge the health status of the tool-changing device, such that the manufacturing process can be stably performed.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A method for confirming a tool of a machining process, applied to an electronic device having a processing program storage device, the electronic device being connected with a processing equipment with tools and a first wireless transmission module, each of the tools mounted on the processing equipment at respective positions having individual tool numbers being furnished at least with a built-in second wireless transmission module, an inertial sensor, a storage unit and a processing unit, the electronic device performing the steps of:
(a) applying the first wireless transmission module to acquire data in the storage unit of each of the tools on the processing equipment;
(b) analyzing the data acquired from the storage unit to obtain an analyzing result, and transforming the analyzing result into a corresponding tool assembling-status data string, wherein the analyzing result includes one of the tool numbers, a tool type, a tool specification and a tool assembly direction;
(c) acquiring a processing program from the processing program storage device, analyzing a tool acquirement corresponding to each one of processes in the processing program, and transforming the tool acquirement into a corresponding process-related tool acquirement data string, wherein the tool acquirement includes a required tool number, a required tool type, a required tool specification and a required tool assembly direction; and
(d) comparing the tool assembling-status data string with the process-related tool acquirement data string, and calculating a difference between the tool assembling-status data string and the process-related tool acquirement data string to form a program and tool matching data string as an output.

2. The method for confirming a tool of a machining process of claim 1, wherein the storage unit of the respective tool contains a stored tool number, a stored tool type and a stored tool specification.

3. The method for confirming a tool of a machining process of claim 1, wherein the processing unit receives an electronic signal from the inertial sensor of the tool, and calculates the electronic signal to obtain a corresponding inertial sensor data respective to the tool assembly direction of the tool.

4. The method for confirming a tool of a machining process of claim 1, wherein the program and tool matching data string stands for a matching and verifying result of the tool on the processing equipment with respect to the corresponding process of the processing program, and the matching and verifying result contains matching results with respect to the tool number, the tool type, the tool specification and the tool assembly direction of the tool.

5. The method for confirming a tool of a machining process of claim 1, further including a step of determining a health status of the tool changing device according to a plurality of locating vibration data of the tool-changing device, wherein, in this step, the plurality of locating vibration data of the tool-changing device is obtained by having the processing unit in the tool to calculate the electronic signal of the inertial sensor.

6. The method for confirming a tool of a machining process of claim 5, wherein data transmission inside the electronic device is applied to obtain the recent plurality of locating vibration data of the tool-changing device, and mathematical statistics is used to perform a kurtosis calculation for determining the health status of the tool changing device.

7. The method for confirming a tool of a machining process of claim 6, wherein, if the calculated kurtosis is above a mesokurtosis, the tool-changing device is in a healthy state; and, if the calculated kurtosis is below the mesokurtosis, the tool-changing device is in an unhealthy state.

8. The method for confirming a tool of a machining process of claim 7, wherein a kurtosis number of the mesokurtosis is equal to 0.

9. A system for confirming a tool of a machining process, comprising:
a tool confirmation program storage device, used for containing a tool data-analyzing module, a process-related tool acquirement-analyzing module and a process-related tool confirmation module; and
a processor, coupled with the tool confirmation program storage device, used for performing at least one of the tool data-analyzing module, the process-related tool acquirement-analyzing module and the process-related tool confirmation module;
wherein the processor performs the tool data-analyzing module to apply a wireless transmission module to acquire and analyze data inside a storage unit of a tool mounted on a processing equipment at a position having an individual tool number to obtain an analyzing result, and the analyzing result is then transformed into a tool assembling-status data string;
wherein the processor performs the process-related tool acquirement-analyzing module to acquire and analyze a tool acquirement respective to a process of a processing problem from a processing program storage device of an electronic device to obtain a tool acquirement information, and the tool acquirement information is transformed into a process-related tool acquirement data string;
wherein the processor performs the process-related tool confirmation module to compare the tool assembling-status data string with the process-related tool acquirement data string and further to calculate a difference between the tool assembling-status data string and the process-related tool acquirement data string to obtain a matching result, and the matching result is outputted as a program and tool matching data string.

10. The system for confirming a tool of a machining process of claim 9, wherein the tool confirmation program storage device further includes a tool-changing device status-analyzing module used for determining a health status of a tool changing device by judging a plurality of locating vibration data of the tool-changing device, and the plurality of locating vibration data of the tool-changing device is obtained by having a processing unit of the tool to calculate an electronic signal of the inertial sensor.
